(19) United States
(12) Patent Application Publication
(10) Pub. No.: US 2026/0128045 A1
(43) Pub. Date: May 7, 2026

(54) SPEECH RECOGNITION SYSTEM AND RELATED SPEECH RECOGNITION METHOD

(71) Applicant: Realtek Semiconductor Corp., HsinChu (TW)

(72) Inventor: Ying-Ying Chao, HsinChu (TW)

(73) Assignee: Realtek Semiconductor Corp., HsinChu (TW)

(21) Appl. No.: 19/363,603

(22) Filed: Oct. 20, 2025

(30) Foreign Application Priority Data
Nov. 7, 2024 (TW) 113142673

(51) Int. Cl. G10L 17/02; G10L 17/04; G10L 17/06; G10L 21/0232

(52) U.S. Cl. CPC G10L 17/02; G10L 17/04; G10L 17/06; G10L 21/0232

(57) ABSTRACT

The present invention provides a voice recognition method, which includes the steps of: receiving a plurality of voice signals; performing a time-domain to frequency-domain conversion operation on the plurality of voice signals to generate a plurality of frequency-domain signals; using a morphological filter to perform filtering operations on the plurality of frequency-domain signals to generate a plurality of filtered backgrounds; generating a plurality of initial voice fingerprints according to the plurality of filtered backgrounds, wherein each of the plurality of initial voice fingerprints comprises times and frequency points corresponding to a plurality of peaks in the corresponding filtered background; generating at least one voice fingerprint according to the plurality of initial voice fingerprints; and storing the at least one voice fingerprint in a memory for subsequent voice recognition operation.

### BACKGROUND OF THE INVENTION

### 1. FIELD OF THE INVENTION

The present invention relates to a speech recognition system.

### 2. DESCRIPTION OF THE PRIOR ART

Due to the uniqueness of each individual's voice, many electronic devices in recent years have been using voiceprints to identify users. However, the uniqueness of a voice is not solely based on differences in the user's vocal structure, but also the user's age and health. Therefore, traditional speech recognition devices typically first perform loudness normalization and Voice Activity Detection (VAD) on the received audio signal, then detecting the segments including speech and performing feature extraction to improve the accuracy of speech recognition. However, the aforementioned loudness normalization and VAD processes increase the design and manufacturing costs of speech recognition devices.

### SUMMARY OF THE INVENTION

Therefore, one of the objectives of the present invention is to provide a speech recognition system that can accurately perform speech recognition without the need for loudness normalization and/or VAD operations, in order to solve the problems described in the prior art.

According to one embodiment of the present invention, a voice recognition system comprising a processing circuit and a memory is disclosed. The processing circuit is configured to perform steps of: receiving a plurality of voice signals; performing a time-domain to frequency-domain conversion operation on the plurality of voice signals to generate a plurality of frequency-domain signals; using a morphological filter to perform filtering operations on the plurality of frequency-domain signals to generate a plurality of filtered backgrounds; generating a plurality of initial voice fingerprints according to the plurality of filtered backgrounds, wherein each of the plurality of initial voice fingerprints comprises times and frequency points corresponding to a plurality of peaks in the corresponding filtered background; generating at least one voice fingerprint according to the plurality of initial voice fingerprints; and storing the at least one voice fingerprint in the memory for subsequent voice recognition operation.

According to one embodiment of the present invention, a voice recognition method comprises the steps of: receiving a plurality of voice signals; performing a time-domain to frequency-domain conversion operation on the plurality of voice signals to generate a plurality of frequency-domain signals; using a morphological filter to perform filtering operations on the plurality of frequency-domain signals to generate a plurality of filtered backgrounds; generating a plurality of initial voice fingerprints according to the plurality of filtered backgrounds, wherein each of the plurality of initial voice fingerprints comprises times and frequency points corresponding to a plurality of peaks in the corresponding filtered background; generating at least one voice fingerprint according to the plurality of initial voice fingerprints; and storing the at least one voice fingerprint in a memory for subsequent voice recognition operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a speech recognition system according to an embodiment of the present invention.

FIG. 2 is a flowchart showing the process of establishing a voiceprint in the speech recognition system according to an embodiment of the present invention.

FIG. 3 is a flowchart showing the filtering operation of a processed frequency-domain signal using a morphological filter to generate a filtered background.

FIG. 4 is a schematic diagram showing the dilation background generated by the morphological filter.

FIG. 5 is a schematic diagram showing the erosion background generated by the morphological filter.

FIG. 6 is a schematic diagram showing how the morphological filter generates a filtered background based on the dilation background and erosion background.

FIG. 7 is a schematic diagram showing the generation of multiple voiceprints based on multiple initial voiceprints.

FIG. 8 is a flowchart showing the process of speech recognition in the speech recognition system according to an embodiment of the present invention.

FIG. 9 is a schematic diagram showing the process of determining whether the voiceprint to be recognized matches a voiceprint stored in memory according to an embodiment of the present invention.

### DETAILED DESCRIPTION

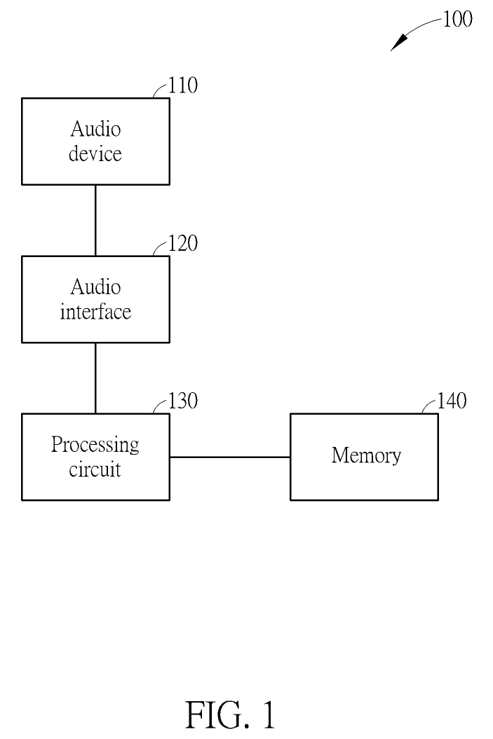

FIG. 1 is a schematic diagram of a speech recognition system 100 according to an embodiment of the present invention. As shown in FIG. 1, the speech recognition system 100 includes a radio device 110, an audio interface 120, a processing circuit 130, and a memory 140. In this embodiment, the speech recognition system 100 can be arranged in an electronic device, such as a smartphone, tablet, laptop, desktop computer, or any other electronic device with speech recognition capabilities. The radio device 110 is used to capture external sound. The memory 140 can be any type of non-volatile memory (NVM).

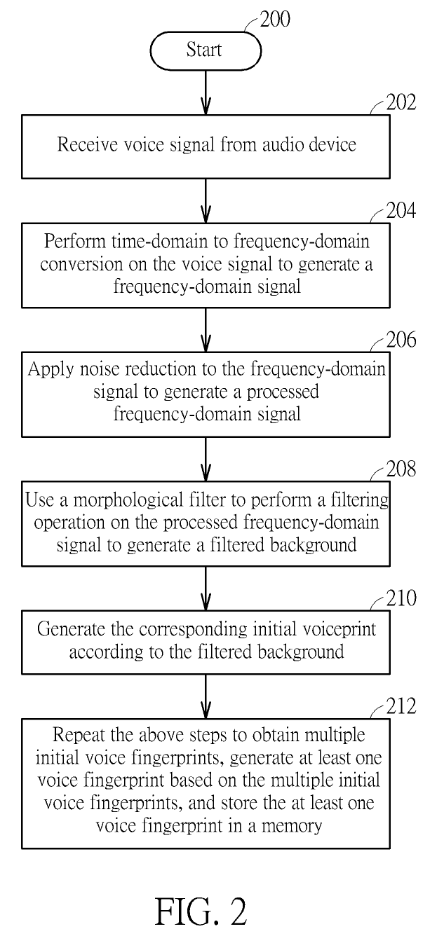

In this embodiment, the user first establishes their voiceprint using the speech recognition system 100. That is, the user will say a few keywords to the system, such as repeating the phrase "Realtek Semiconductor" three times, allowing the speech recognition system 100 to establish a voiceprint for future recognition of the user's voice. FIG. 2 is a flowchart showing the process of establishing a voiceprint in the speech recognition system 100 according to an embodiment of the present invention. In Step 200, the flow starts, and the speech recognition system 100 is enabled and completes the initialization operation, and the user controls the speech recognition system 100 to start the voiceprint establishment process. In Step 202, the user says the keyword, and the processing circuit 130 receives the user's voice signal through the audio interface 120 and the audio device 110. In Step 204, the processing circuit 130 performs a time-domain to frequency-domain conversion on the user's voice signal, such as performing a Fast Fourier Transform (FFT), to generate a frequency-domain signal. In Step 206, the processing circuit 130 applies noise reduction to the frequency-domain signal to generate a processed frequency-domain signal.

It should be noted that the details of the time-domain to frequency-domain conversion operation and noise reduction processing in Steps 204 and 206 are well-known to those skilled in the art, and since these operations are not the focus of the present invention, the relevant details are not described here.

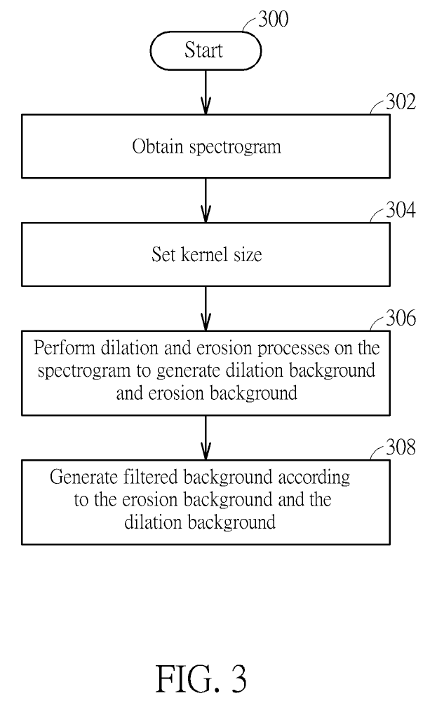

In Step 208, the processing circuit 130 uses a morphological filter to perform a filtering operation on the processed frequency-domain signal to generate a filtered background. Specifically, refer to FIG. 3, which illustrates the flowchart of using a morphological filter to perform the filtering operation on the processed frequency-domain signal to generate the filtered background. In Step 300, the flow starts. In Step 302, the processing circuit 130 generates a spectrogram based on the processed frequency-domain signal. The spectrogram, also known as a time-frequency spectrum, is used to describe how the intensity of each frequency component of a signal changes over time. Taking a three-dimensional coordinate system as an example, the x-axis represents time, with each unit on the x-axis being a frame, and the duration of each frame can be determined by the engineer's design, for example, 34.83 milliseconds. The y-axis represents frequency, with each unit on the y-axis being a frequency point, and the distance between two adjacent frequency points can be determined by the engineer’s design, for example, 21.53 Hz. The z-axis represents intensity, measured in decibels (dB).

In Step 304, the processing circuit 130 sets a kernel, where the size of the kernel can be 3x3, 5x5, or any other suitable dimensions.

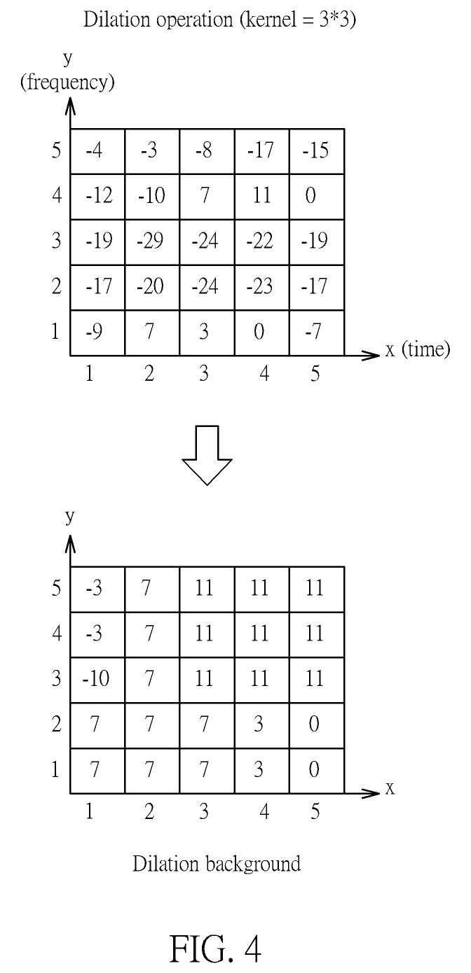

In Step 306, the processing circuit 130 performs dilation and erosion processes on the spectrogram to generate a dilation background and an erosion background, respectively. Specifically, refer to FIG. 4, which illustrates a schematic diagram of generating the dilation background. As shown in FIG. 4, assume the kernel size set in Step 304 is 3x3, and the 5x5 matrix above represents a portion of the spectrogram, where each unit on the x-axis represents a frame and each unit on the y-axis represents a frequency point, with each internal value representing intensity (in dB). The processing circuit 130 moves the center of the kernel to each unit on the spectrogram and selects the maximum value within the kernel to assign as the corresponding value in the dilation background. For example, taking the value at (x, y) = (1, 5) as an illustration, the values within the 3x3 kernel centered at (x, y) = (1, 5) are "-4", "-3", "-12" and "-10". Since the maximum value among these four numbers is "-3", the processing circuit 130 assigns the value "-3" to the dilation background at (x, y) = (1, 5). In addition, for (x, y) = (3, 3) in the spectrogram, the values within the 3x3 kernel centered at (x, y) = (3, 3) are "-10", "7", "11", "-29", "-24", "-22", "-20", "-24" and "-23". Since the maximum value among these nine numbers is "11", the processing circuit 130 assigns the value "11" to the dilation background at (x, y) = (3, 3).

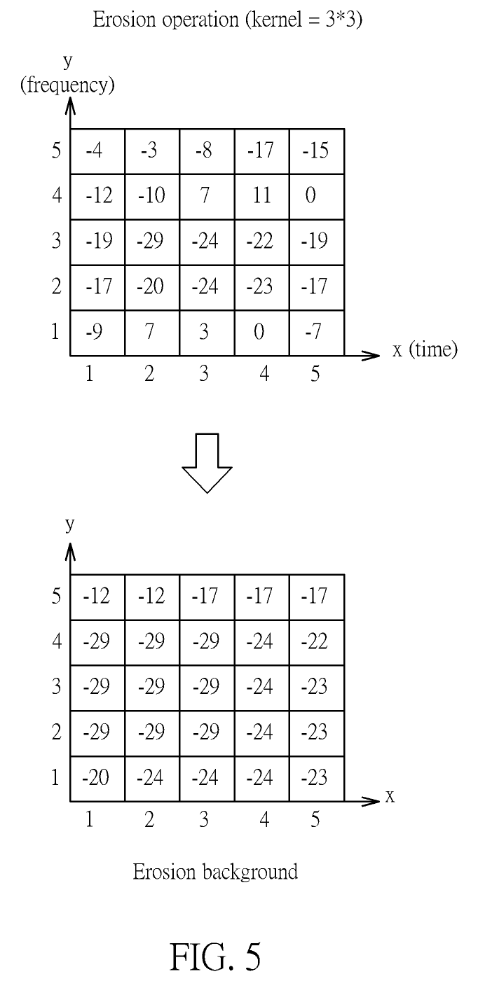

In addition, refer to FIG. 5, which illustrates a schematic diagram of generating the erosion background. As shown in FIG. 5, assume the kernel size set in Step 304 is 3x3, and the 5x5 matrix above represents a portion of the spectrogram, where each unit on the x-axis represents a frame, each unit on the y-axis represents a frequency point, and each internal value represents intensity (in dB). The processing circuit 130 moves the center of the kernel to each unit on the spectrogram and selects the minimum value within the kernel to assign as the corresponding value in the erosion background. For example, taking the value at (x, y) = (1, 5) as an illustration, the values within the 3x3 kernel centered at (x, y) = (1, 5) are "-4", "-3", "-12", and "-10". Since the minimum value among these four numbers is "-12", the processing circuit 130 assigns the value "-12" to the erosion background at (x, y) = (1, 5). In addition, for (x, y) = (3, 3) in the spectrogram, the values within the 3x3 kernel centered at (x, y) = (3, 3) are "-10", "7", "11", "-29", "-24", "-22", "-20", "-24", and "-23". Since the minimum value among these nine numbers is "-29", the processing circuit 130 assigns the value "-29" to the erosion background at (x, y) = (3, 3).

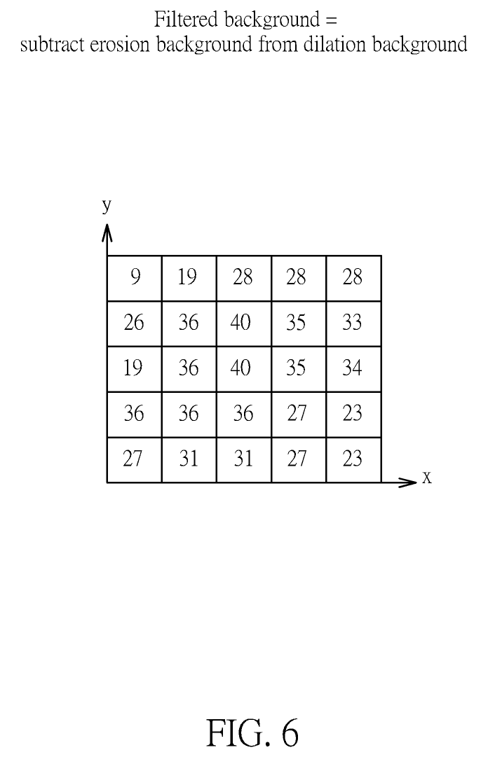

In Step 308, referring to FIG. 6, the processing circuit 130 subtracts the erosion background from the dilation background to obtain the filtered background. In this embodiment, the value (z-axis) of each unit in the filtered background represents the difference in intensity between the corresponding unit (x, y) in the spectrogram and its neighboring units. In other words, for a unit in the filtered background with larger value, this indicates a greater difference in intensity between the unit and its neighboring units. Conversely, for a unit with smaller value in the filtered background, this indicates a smaller difference in intensity between the unit and its neighboring units.

Next, returning to Step 210 in FIG. 2, the processing circuit 130 generates the corresponding initial voiceprint according to the filtered background. In this embodiment, the processing circuit 130 can determine multiple peaks in the spectrogram according to the filtered background and the spectrogram itself, and then generate the corresponding initial voiceprint. In one embodiment, the processing circuit 130 may use the following three conditions to identify the multiple peaks in the spectrogram: (1) the frequency point is between a predetermined minimum frequency and a predetermined maximum frequency, where the predetermined minimum and maximum frequencies can be, for example, 80 Hz and 3000 Hz, or any other suitable frequency range. (2) The intensity of the filtered background is greater than or equal to a first threshold value, such as 40 dB. (3) the intensity in the spectrogram is greater than or equal to a second threshold value, such as 5 dB. For example, referring to FIG. 4 to FIG. 6, assume that only the frequency range y = 3 to 5 falls between the predetermined minimum and maximum frequencies. In this case, only the unit (x, y) = (3, 4) in the filtered background has an intensity greater than or equal to the first threshold value (40 dB), and the intensity in the spectrogram is greater than or equal to the second threshold value (5 dB). Therefore, the unit (x, y) = (3, 4) in the spectrogram is determined to be a peak.

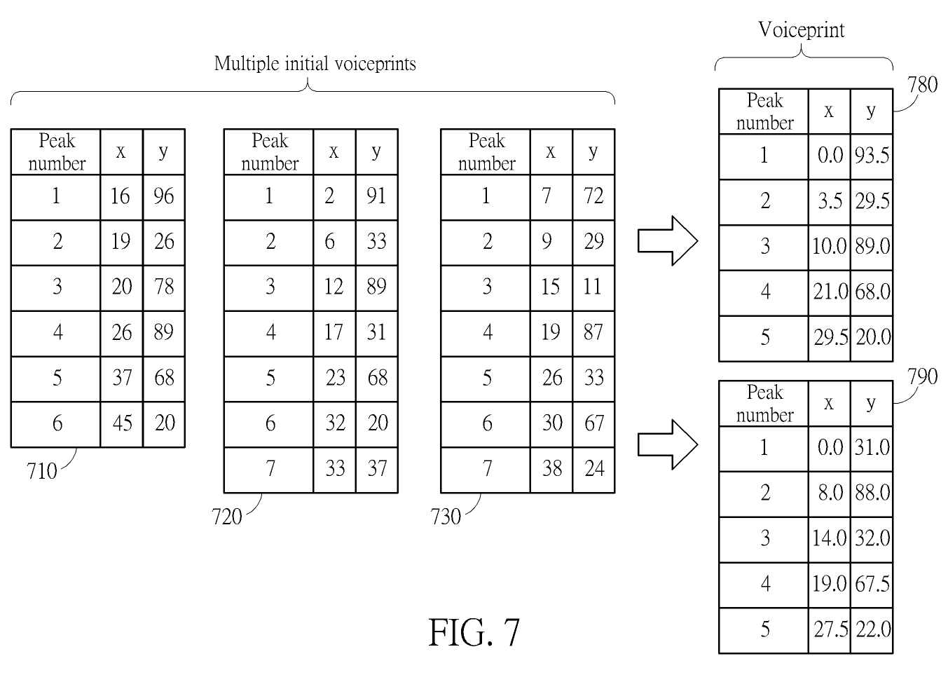

In this embodiment, when the user speaks a keyword once, the aforementioned process is performed to generate multiple peaks, and the (x, y) coordinates corresponding to these peaks form an initial voiceprint. In this embodiment, since the user will sequentially speak the keyword multiple times, the processing circuit 130 will generate multiple initial voiceprints. Refer to FIG. 7, it illustrates three initial voiceprints 710, 720, and 730, where each initial voiceprint 710, 720, and 730 includes the (x, y) coordinates corresponding to multiple peaks.

In Step 212, the processing circuit 130 generates at least one voiceprint based on the multiple initial voiceprints and stores the at least one voiceprint in the memory 140. Referring to FIG. 7, the processing circuit 130 generates a voiceprint 780 according to the initial voiceprints 710 and 720. For example, the processing circuit 130 can identify the peak numbers in the initial voiceprints 710 and 720 that have matching time intervals (i.e., similar time intervals) and perform a weighted calculation (e.g., averaging) on the two frequency points corresponding to the peak numbers in the initial voiceprints 710 and 720 to determine the corresponding frequency points in the voiceprint 780. For example, in FIG. 7, the time intervals between the peak numbers "1", "2", "4", "5", and "6" in initial voiceprint 710 are "3", "7", "11" and "8", respectively. In initial voiceprint 720, the time intervals between the peak numbers "1", "2", "3", "5", and "6" are "4", "6", "11" and "9", respectively. Since the time intervals between the peak numbers "1", "2", "4", "5", and "6" in initial voiceprint 710 and the peak numbers "1", "2", "3", "5", and "6" in initial voiceprint 720 are similar (e.g., the interval differences are smaller than a threshold value), the average time interval between these corresponding peak numbers can be used as the time interval in the voiceprint 780. That is, the x-axis (time) values for the peak numbers "1" to "5" in voiceprint 780 can be set to "0", "3.5", "10", "21", and "29.5". In addition, the frequency points corresponding to the peak numbers "1", "2", "4", "5", and "6" in initial voiceprint 710 and the frequency points corresponding to the peak numbers "1", "2", "3", "5", and "6" in initial voiceprint 720 can be weighted and summed (e.g., averaged) to obtain the frequency points for the peak numbers "1" to "5" in voiceprint 780. For example, the y-axis (frequency point) values for peak numbers "1" to "5" in voiceprint 780 can be set to "93.5", "29.5", "89", "68", and "20".

In one embodiment, the process of identifying the peak numbers with matching time intervals in the initial voiceprints 710 and 720 can be implemented using a recursive exhaustive search method, or any other suitable mathematical approach.

Similarly, the processing circuit 130 can identify the peak numbers with similar time intervals in the initial voiceprints 720 and 730, and perform weighted calculations (e.g., averaging) on the corresponding frequency points in initial voiceprints 720 and 730 to obtain the frequency points for the corresponding peaks in voiceprint 790. For example, referring to FIG. 7, since the peak numbers "2", "3", "4", "5", "6" in initial voiceprint 720 and the peak numbers "2", "4", "5", "6", "7" in initial voiceprint 730 have similar time intervals (e.g., the difference in intervals is smaller than a threshold), the average of time intervals between the peak numbers “2”, “3”, “4”, “5” and “6” of the initial voice fingerprint 720 and the time intervals between the peak numbers “2”, “4”, “5”, “6" and "7" of the initial voice fingerprint 730 can be used as the time interval of voice fingerprint 790. That is, the x-axis (time) for peak numbers "1" to "5" in voiceprint 790 can be set as "0", "8", "14", "19", "27.5". In addition, the corresponding frequency points for the peak numbers "2", "3", "4", "5", "6" in initial voiceprint 720 and peak numbers "2", "4", "5", "6", "7" in initial voiceprint 730 can also be weighted and averaged to obtain the frequency points for peak numbers "1" to "5" in voiceprint 790. For example, the y-axis (frequency point) values for peak numbers "1" to "5" in voiceprint 790 can be set as "31", "88", "32", "67.5" and "22".

It should be noted that the detailed operations described in the above embodiments for determining two voiceprints 780 and 790 based on multiple initial voiceprints 710, 720 and 730 are provided as examples and are not intended to limit the present invention. In other embodiments, as long as the processing circuit 130 can perform similarity matching on two or more initial voiceprints to determine the corresponding x-axis (time) and y-axis (frequency points) values for the peak numbers of multiple voiceprints, designers may use any suitable algorithm. These alternative designs should fall within the scope of the present invention.

In one embodiment, if the number of matching peak numbers found between two initial voiceprints is less than a threshold value, such as less than half of the peak numbers in the initial voiceprint 710, the processing circuit 710 determines that the similarity matching between the two initial voiceprints has failed and a voiceprint cannot be determined. In another embodiment, if any pair of matching peak numbers between the two initial voiceprints has a frequency difference greater than a threshold value, such as greater than 150 Hz, the processing circuit 710 also determines that the similarity matching between the two initial voiceprints has failed and a voiceprint cannot be determined.

Finally, after the processing circuit 130 stores at least one voiceprint, such as the voiceprints 780 and 790 shown in FIG. 7, into the memory 140 for subsequent speech recognition, the process of establishing the voiceprint in the speech recognition system 100 ends.

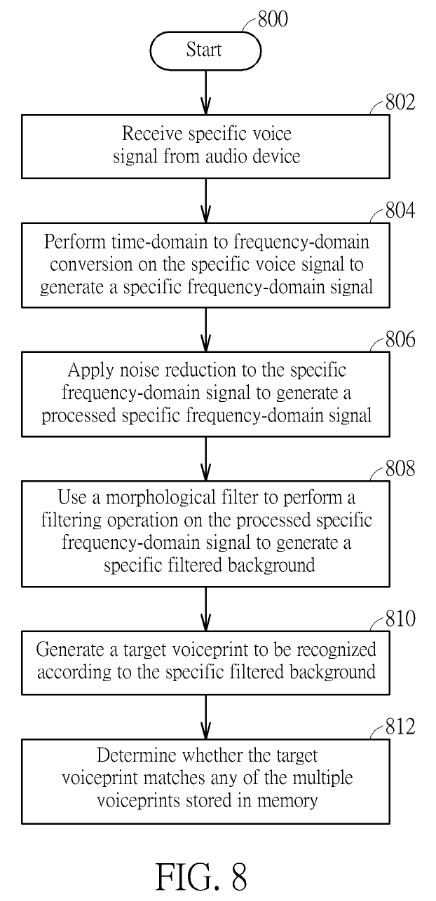

FIG. 8 is a flowchart illustrating the speech recognition process in the speech recognition system 800 according to an embodiment of the present invention. In Step 800, the flow starts and the speech recognition system 100 is enabled and completes initialization, and the memory 140 having stored voiceprints for speech recognition, such as the voiceprints 780 and 790 shown in FIG. 7. In Step 802, the user speaks a keyword, and the processing circuit 130 receives the user's specific voice signal through the audio interface 120 and the audio device 110. In Step 804, the processing circuit 130 performs a time-domain to frequency-domain conversion operation on the specific voice signal, such as performing a FFT operation, to generate a specific frequency-domain signal. In Step 806, the processing circuit 130 applies noise reduction processing to the specific frequency-domain signal to generate a processed specific frequency-domain signal.

In Step 808, the processing circuit 130 uses a morphological filter to perform a filtering operation on the processed specific frequency-domain signal to generate a specific filtered background. The operation in Step 808 is the same as the operation in Step 208 as shown in FIG. 2.

In Step 810, the processing circuit 130 generates a target voiceprint to be recognized according to the specific filtered background. The operation in Step 810 is the same as Step 210 shown in FIG. 2, that is the calculation process for generating the target voiceprint in Step 810 is the same as the calculation process for generating the initial voiceprint in Step 210.

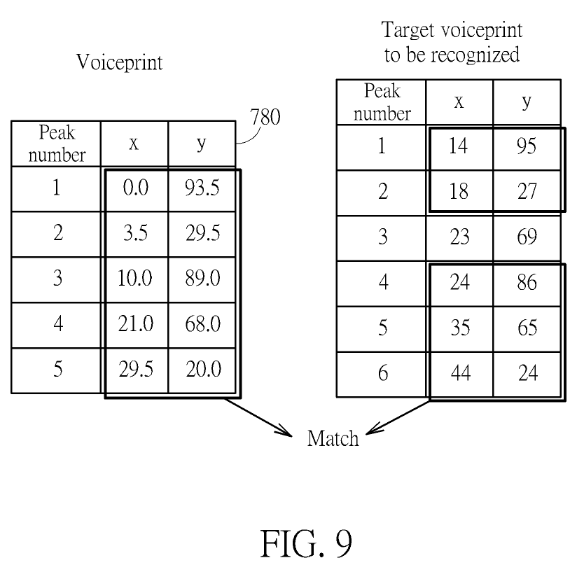

In Step 812, the processing circuit 130 determines whether the target voiceprint matches any of the multiple voiceprints 780, 790 stored in memory 140, in order to determine whether the target voiceprint and the voiceprints 780, 790 come from the same user. Referring to FIG. 9, the processing circuit 130 checks if there are multiple peak numbers in the target voiceprint, where the time (x) and frequency (y) differences with the time (x) and frequency (y) corresponding to peak numbers "1" to "5" of the voiceprint 780 are within a range (i.e., less than a threshold). If this condition is met, the processing circuit 130 determines that the target voiceprint matches the voiceprint 780, and both the target voiceprint and voiceprint 780 come from the same user. Otherwise, the processing circuit 130 determines that the target voiceprint does not match the voiceprint 780, and the two voiceprints do not come from the same user. In the example of FIG. 9, since the differences between the time intervals corresponding to peak numbers "1", "2", "4", "5", and "6" in the target voiceprint and the time intervals corresponding to peak numbers "1" to "5" in initial voiceprint 730 are all less than a threshold value, and the frequency differences between the peak numbers "1", "2", "4", "5", and "6" in the target voiceprint and the peak numbers "1" to "5" in initial voiceprint 730 are also below the threshold, the processing circuit 130 determines that the target voiceprint matches the voiceprint 780.

After determining that the target voiceprint matches the voiceprint 780, the processing circuit 130 may perform specific operations, such as unlocking certain functions of an electronic device, or waking up the electronic device, and so on.

In the embodiment of the present invention, as shown in the examples of FIG. 2 and FIG. 8, the process of establishing voiceprints and performing voice recognition in the speech recognition system relies on matching based on the time (x-axis) and frequency (y-axis) corresponding to multiple peak numbers of the voiceprint. Therefore, there is no need to perform voice activity detection or volume normalization operations, which reduces the design and manufacturing costs of the voice recognition device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voice recognition system, comprising:
a processing circuit; and
a memory;
wherein the processing circuit is configured to perform steps of:
receiving a plurality of voice signals;
performing a time-domain to frequency-domain conversion operation on the plurality of voice signals to generate a plurality of frequency-domain signals;
using a morphological filter to perform filtering operations on the plurality of frequency-domain signals to generate a plurality of filtered backgrounds;
generating a plurality of initial voice fingerprints according to the plurality of filtered backgrounds, wherein each of the plurality of initial voice fingerprints comprises times and frequency points corresponding to a plurality of peaks in the corresponding filtered background;
generating at least one voice fingerprint according to the plurality of initial voice fingerprints; and
storing the at least one voice fingerprint in the memory for subsequent voice recognition operation.

2. The voice recognition system of claim 1, wherein the step of generating the at least one voice fingerprint according to the plurality of initial voice fingerprints comprises:
performing similarity matching on at least two of the plurality of initial voice fingerprints to determine the times and frequency points corresponding to a plurality of peaks of the at least one voice fingerprint.

3. The voice recognition system of claim 2, wherein the step of performing the similarity matching on the at least two of the plurality of initial voice fingerprints to determine the times and frequency points corresponding to the plurality of peaks of the at least one voice fingerprint comprises:
Searching for multiple peaks with matching time intervals in the at least two of the plurality of initial voice fingerprints, and determining the time and frequency points corresponding to the multiple peaks of the at least one voice fingerprint according to the time and frequency points corresponding to the multiple peaks with matching time intervals in the at least two of the plurality of initial voice fingerprints.

4. The voice recognition system of claim 1, wherein the plurality of voice signals are generated by a user speaking a same keyword at different times.

5. The voice recognition system of claim 1, wherein the processing circuit further performs steps of:
receiving a specific voice signal;
performing the time-domain to frequency-domain conversion operation on the specific voice signal to generate a specific frequency-domain signal;
using the morphological filter to perform the filtering operation on the specific frequency-domain signal to generate a specific filtered background;
generating a target voiceprint to be recognized according to the specific filtered background; and
determining whether the target voiceprint matches the at least one voiceprint.

6. A voice recognition method, comprising:
receiving a plurality of voice signals;
performing a time-domain to frequency-domain conversion operation on the plurality of voice signals to generate a plurality of frequency-domain signals;
using a morphological filter to perform filtering operations on the plurality of frequency-domain signals to generate a plurality of filtered backgrounds;
generating a plurality of initial voice fingerprints according to the plurality of filtered backgrounds, wherein each of the plurality of initial voice fingerprints comprises times and frequency points corresponding to a plurality of peaks in the corresponding filtered background;
generating at least one voice fingerprint according to the plurality of initial voice fingerprints; and
storing the at least one voice fingerprint in a memory for subsequent voice recognition operation.

7. The voice recognition method of claim 6, wherein the step of generating the at least one voice fingerprint according to the plurality of initial voice fingerprints comprises:
performing similarity matching on at least two of the plurality of initial voice fingerprints to determine the times and frequency points corresponding to a plurality of peaks of the at least one voice fingerprint.

8. The voice recognition method of claim 7, wherein the step of performing the similarity matching on the at least two of the plurality of initial voice fingerprints to determine the times and frequency points corresponding to the plurality of peaks of the at least one voice fingerprint comprises:
Searching for multiple peaks with matching time intervals in the at least two of the plurality of initial voice fingerprints, and determining the time and frequency points corresponding to the multiple peaks of the at least one voice fingerprint according to the time and frequency points corresponding to the multiple peaks with matching time intervals in the at least two of the plurality of initial voice fingerprints.

9. The voice recognition method of claim 6, wherein the plurality of voice signals are generated by a user speaking a same keyword at different times.

10. The voice recognition method of claim 6, further comprising:
receiving a specific voice signal;
performing the time-domain to frequency-domain conversion operation on the specific voice signal to generate a specific frequency-domain signal;
using the morphological filter to perform the filtering operation on the specific frequency-domain signal to generate a specific filtered background;
generating a target voiceprint to be recognized according to the specific filtered background; and
determining whether the target voiceprint matches the at least one voiceprint.
